(19) United States
(12) Patent Application Publication
(10) Pub. No.: US 2014/0190568 A1
(43) Pub. Date: Jul. 10, 2014

(54) Coolant Activated Rechargeable Energy Storage System Drain Plug

(71) Applicant: GM GLOBAL TECHNOLOGY OPERATIONS LLC, Detroit, MI (US)

(72) Inventors: Herman K. Phlegm, Oak Park, MI (US); William J. Wallace, Warren, MI (US); Mahmoud H. Abd Elhamid, Troy, MI (US); Andrew C. Brenz, Troy, MI (US); Milind S. Gandhi, Shelby Township, MI (US); Andrew J. Namou, West Bloomfield, MI (US); Craig A. Kollar, Sterling Heights, MI (US)

(73) Assignee: GM GLOBAL TECHNOLOGY OPERATIONS LLC, Detroit, MI (US)

(21) Appl. No.: 13/736,197

(22) Filed: Jan. 8, 2013

(51) Int. Cl. H01M 2/36

(52) U.S. Cl. CPC H01M 2/36
USPC 137/1; 429/83

(57) ABSTRACT

A battery pack with a drain plug. The drain plug includes a carrier defining a cavity internal to the carrier, an inlet disposed on a first surface of the carrier and an outlet disposed on a second surface of the carrier where the first surface and the second surface fluidly displaced from one another and coupled to the cavity. A soluble plug may be disposed within the cavity of the carrier; the soluble plug is configured to at least partially dissolve when fluidly coupled with a coolant allowing a portion of the coolant to flow between the inlet and the outlet and out of the battery pack. A first lead and a second lead are configured to signally connect an impedance element that is cooperative with the carrier, to a circuit such that when the continuity of the circuit is interrupted, the circuit provides notification of the activation of the drain plug to the on-board computer systems.

### CROSS REFERENCE TO RELATED APPLICATIONS

The present application hereby is related to U.S. application Ser. No. ______ filed ______, entitled “Deflection Sensitive Coolant Activated Drain Plug Detection System for High Voltage Battery Packs,” attorney docket # P020498-FCA-CHE.

### BACKGROUND OF THE INVENTION

The invention relates generally to the thermal management of battery-based power systems, and more particularly to draining coolant in the event of a coolant breach within such a system.

Lithium-ion and related batteries, collectively known as a rechargeable energy storage system (RESS), are being used in automotive applications as a way to supplement, in the case of hybrid electric vehicles (HEVs), or supplant, in the case of purely electric vehicles (EVs), conventional internal combustion engines (ICEs). The ability to passively store energy from stationary and portable sources, as well as from recaptured kinetic energy provided by the vehicle and its components, makes batteries ideal to serve as part of a propulsion system for cars, trucks, buses, motorcycles and related vehicular platforms. In the present context, a cell is a single electrochemical unit, whereas a battery is made up of one or more cells joined in series, parallel or both, depending on desired output voltage and capacity.

Because an energized battery cell, module, section or pack is capable of producing large amounts of energy, temperature (and the removal of excess quantities thereof) is one of the most significant factors impacting both the performance and life of a battery. To keep temperature excesses from occurring, cooling systems are frequently integrated into a RESS based platform. In one conventional form, the cooling system circulates a liquid-based coolant using alcohol, water or a combination thereof. Typically, the RESS is configured to promote as much contact between the heat-generating portions of the individual cells and the coolant as possible. However, the same cooling system that provides necessary heat-removal may—in the event of an internal failure of one or more battery cells due to a crash event, component wear or a manufacturing defect—lead to leakage of the coolant onto sensitive electrical components (such as circuit boards or the like) in and around the individual cells. Such leakage may provide an efficient and unintended path for the conveyance of the electrical current being generated by the batteries such that in one undesirable form, the leaked coolant may lead to a short circuit of these sensitive system components.

It would be beneficial to provide early detection of loss of coolant into the battery following an accident or related incident to avoid harm to a RESS. It would be further beneficial to implement automated corrective actions in the event of a detected or imminent leakage of coolant into sensitive portions of a battery system.

### SUMMARY OF THE INVENTION

In one embodiment, an apparatus for a drain plug assembly may include a carrier configured to provide structural rigidity to the drain plug, the carrier defining a cavity therein, an inlet disposed on a first surface of the carrier, an outlet disposed on a second surface of the carrier, and the first surface and the second surface fluidly displaced from one another and coupled to the cavity. A soluble plug may be disposed within the cavity of the carrier along with an impedance element. A circuit may be configured to measure an impedance change in the impedance element and a first lead and a second lead may be configured to signally connect the impedance element to the circuit.

In another embodiment, an apparatus for a liquid cooled battery pack may include a plurality of batteries, a cooling circuit comprising a containment vessel coupled with a cooling inlet and a cooling outlet and enclosing a battery housing, the battery housing enclosing the plurality of batteries and comprising a drain outlet. A drain plug may be disposed within the drain outlet and including a carrier configured to provide structural rigidity to the drain plug, the carrier defining a cavity therein, an inlet disposed on a first surface of the carrier, an outlet disposed on a second surface of the carrier, the first surface and the second surface fluidly displaced from one another and coupled to the cavity, a soluble plug disposed within the cavity of the carrier, and an impedance element disposed within the cavity of the carrier. A circuit configured to measure an impedance change in the impedance element and provide an indication when an output equals a threshold resistance value where a first lead and a second lead to electrically couple the impedance element to the circuit, and the soluble plug may be configured to at least partially dissolve when fluidly coupled with a coolant allowing a portion of the coolant to flow between the battery housing and the drain outlet.

In yet another embodiment, a method for draining a liquid coolant from an automotive liquid cooled battery pack may include circulating the liquid coolant around a battery housing of a battery pack and draining the liquid coolant from the battery housing with a drain plug in the event of a leak, the drain plug including a carrier configured to provide structural rigidity to the drain plug, the carrier defining a cavity therein, an inlet disposed on a first surface of the carrier, an outlet disposed on a second surface of the carrier, the first surface and the second surface fluidly displaced from one another and coupled to the cavity, a soluble plug disposed within the cavity of the carrier, with an impedance element cooperative with the carrier and indicating when the leak occurs using a circuit configured to detect a loss of continuity in the impedance element.

These and additional features provided by the embodiments described herein will be more fully understood in view of the following detailed description, in conjunction with the drawings.

### BRIEF DESCRIPTION OF THE DRAWINGS

The following detailed description of the preferred embodiments of the present invention can be best understood when read in conjunction with the following drawings, where like structure is indicated with like reference numerals and in which:

FIG. 1 is a perspective view of a coolant activated drain plug;

FIG. 2 shows a cross-section of the coolant activated drain plug of FIG. 1;

FIG. 3 is a cross-section of one embodiment of the coolant activated drain plug;

FIGS. 4A and 4B are side views of another embodiment of the coolant activated drain plug in an opened and closed position;

FIGS. 5A and 5B are side views of another embodiment of the coolant activated drain plug in the opened and closed position;

FIGS. 6A and 6B are side views of another embodiment of the coolant activated drain plug in the opened and closed position;

FIG. 7 is depicts the component sets of a circuit used to indicate a coolant leak has occurred;

FIG. 8 depicts a fall-away circuit;

FIGS. 9A and 9B depict another embodiment of the fall-away circuit; and

FIG. 10 illustrates a liquid cooled battery pack.

### DETAILED DESCRIPTION OF THE PREFERRED EMBODIMENTS

The present application discloses several embodiments of a drain plug for use in a high voltage battery pack that may be used in the event of an electric vehicle crash or coolant containment malfunction to avoid having the coolant provide an unintended electrical path or short out the batteries or the electronics associated with the battery pack. Embodiments of the drain plug allow for the coolant to be drained from the battery pack in the event of a crash or coolant containment malfunction when the drain plug comes into contact with the coolant before damage to the battery pack or associated electronics can occur. An associated circuit with the drain plug provides notification of the activation of the drain plug to the on-board computer systems.

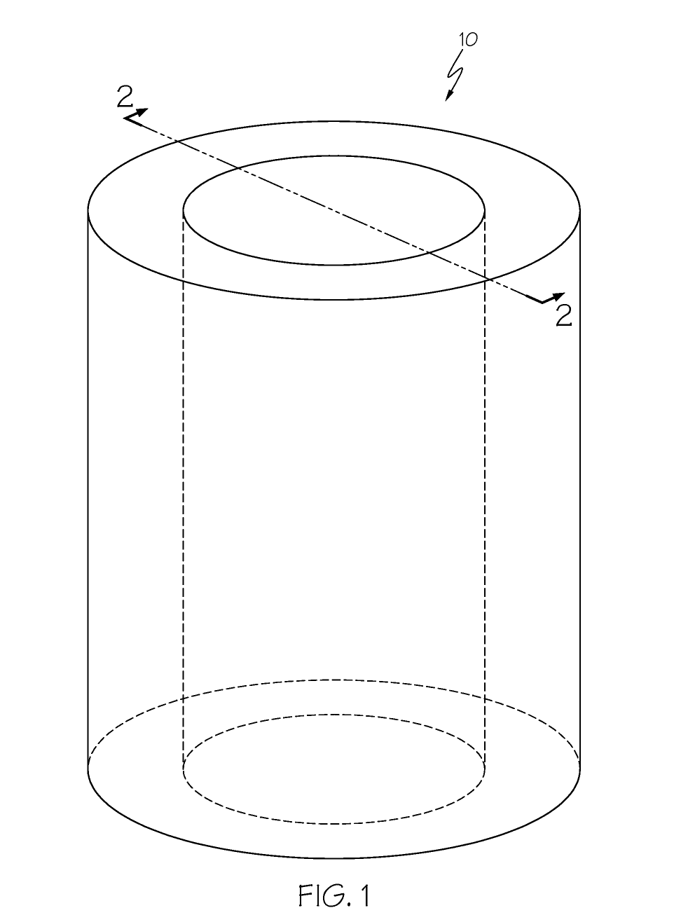

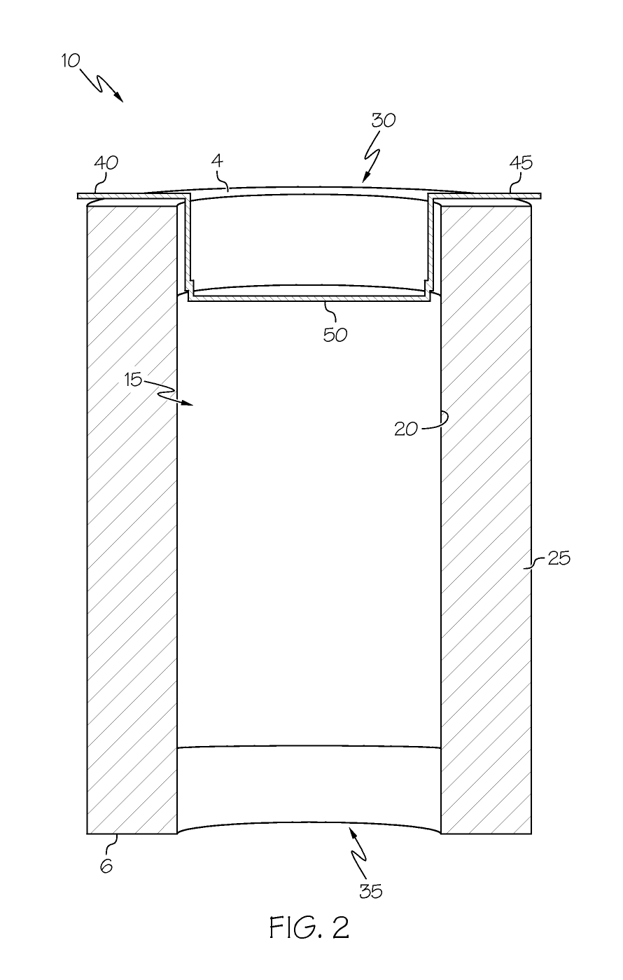

FIG. 1 is a perspective view of a coolant activated drain plug 10 showing the cross-sectional cut for FIG. 2 with a first surface 4 and a second surface 6. Referring now to FIG. 2, the drain plug 10 has a carrier 25 that serves as the support and provides the structural rigidity for the drain plug 10. The carrier 25 has an inlet 30 disposed on the first surface 4 and an outlet 35 disposed on the second surface 6 spaced apart along the carrier 25 and coupled to a cavity 20. A soluble plug 15 is disposed within the cavity 20 and may be a soluble polymer which will dissolve upon contact with the coolant or a non-soluble core with a soluble polymer coating. A polyvinyl alcohol (PVA) foam core is an example of a soluble polymer. The outlet 35 may be configured to drain the coolant out into the atmosphere or into a bladder or other containment device.

When a coolant leak occurs, the soluble plug 15 may first come into contact with the coolant at the inlet 30. A dissolving rate of the soluble plug is controlled by a number of factors to include: a height of the soluble plug, cross-linking density, humidity, and temperature. The height of the soluble plug 15 is the distance between the inlet 30 and the outlet 35 that the soluble plug 15 occupies within the cavity 20. The height of the soluble plug 15 may be adjusted to change the dissolving rate required before the drain plug 10 is opened at the outlet 35 and releases the coolant from the battery pack.

Furthermore, as explained below in greater detail, an impedance element 50 used to detect when the drain plug 10 is in a state of dissolving, is cooperative with the carrier 25 and may be placed at varying heights within the soluble plug 15. This allows for a detection of coolant to occur at a specified point in the dissolving process and may be used to avoid false leak detection in the event of normal operation of the vehicle causes the soluble plug 15 to erode, such as for example, temperature, caustic vapors, etc. The soluble plug 15 composition may be adjusted to match the humidity of the environment in which it is placed to ensure that the drain plug 10 does not erode prematurely. As used throughout this application, eroding is the wearing away of the soluble plug 15 due to other factors besides dissolving.

The impedance element 50 is disposed within the cavity 20. The impedance element 50 is electrically coupled to a circuit (described below) via a first lead 40 and a second lead 45. In some embodiments, the soluble plug 15 may be used as the impedance element 50. The impedance of the soluble plug 15 may be electrically sensed between the first lead 40 and the second lead. As the soluble plug 15 is dissolved by the coolant, as for example in the case of a coolant leak, the impedance of the soluble plug 15 would increase until eventually it would reach a high resistance state as the soluble plug 15 completely dissolves compared to its initial low resistance state. The high resistiance state indicates a loss of continuity in the impedance element 50, soluble plug 15, or a conductive coating. In some embodiments, the impedance element may be the conductive coating electrically coupled to the first lead 40 to the second lead 45. The conductive coating may be made from any material that conducts electricity to include conductive polymers, conductive epoxy, or metal, as for example, the metal coating may be silver, copper, zinc, nickel, gold, or aluminum. The conductive coating may be on the surface of the soluble plug 15 or it may be a conductive ring embedded within the soluble plug 15.

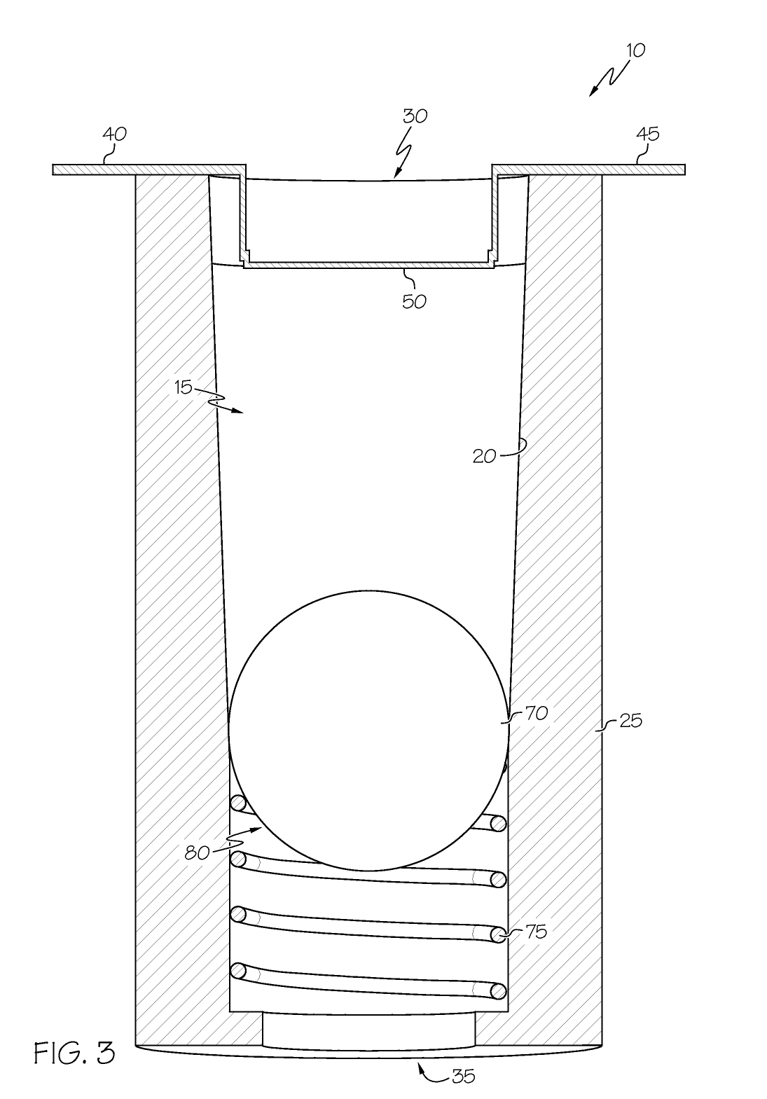

FIG. 3 is a cross sectional view of the drain plug 10 with a check valve 80. The drain plug 10 has the inlet 30 and the outlet 35 spaced apart along the carrier 25 and structurally coupled to the cavity 20. The impedance element 50 may be connected to the circuit with the first lead 40 and the second lead 45. The soluble plug 15 may be disposed within the cavity 20 and serves the dual purpose of dissolving to release coolant from the battery pack and to restrain the check valve 80 in a closed position as shown in FIG. 3. The check valve 80 comprises a stopper 70 that is biased toward the inlet 30 by a coil spring 75. The check valve 80 provides protection to the soluble plug 15 from external moisture from the outlet 35 side of the drain plug 10. When the soluble plug 15 is dissolved, the check valve 80 is unrestrained and opens to an open position allowing the coolant to drain from the battery pack.

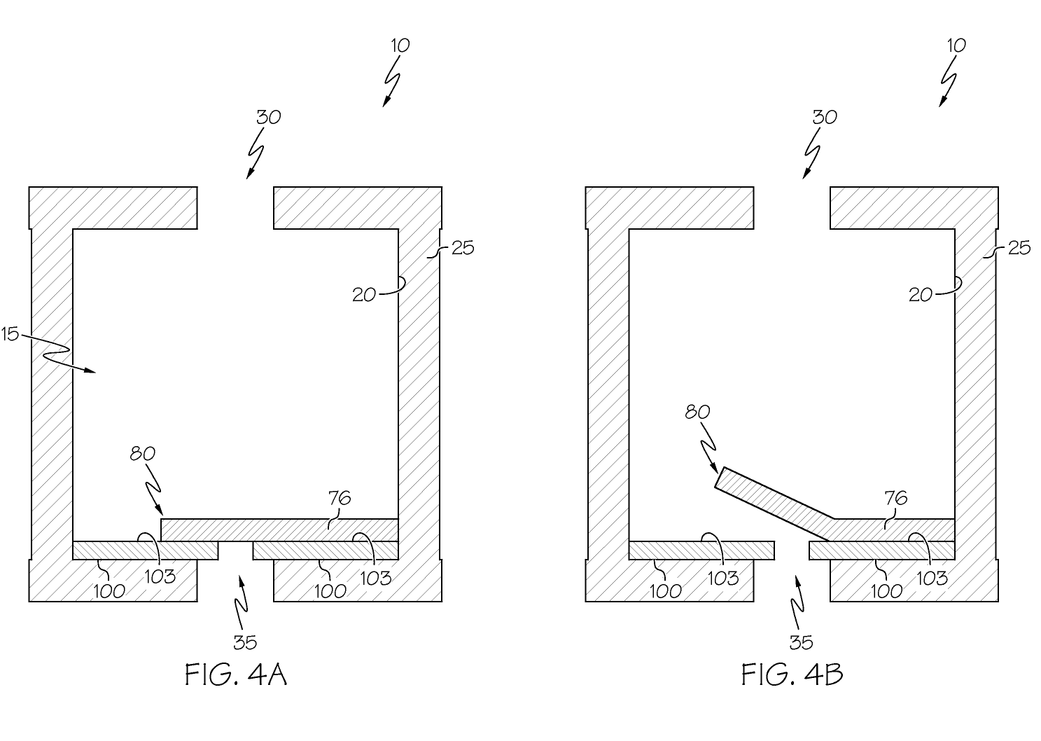

FIGS. 4A and 4B depict another embodiment of the check valve 80 of the drain plug 10. A spring plate 76 is restrained in a closed position by the soluble plug 15 as illustrated by FIG. 4A. A seal 100 is disposed below the spring plate 76 to provide a sealing surface 103 between the spring plate 76 and the carrier 25 to keep out external moisture from entering the drain plug 10. As coolant enters the inlet 30 and dissolves the soluble plug 15, the spring plate 76 springs to an open position as shown in FIG. 4B allowing the coolant to exit the battery pack through the outlet 35. The spring plate 76 may be made from any material that provides a biasing force to include 1090 spring steel.

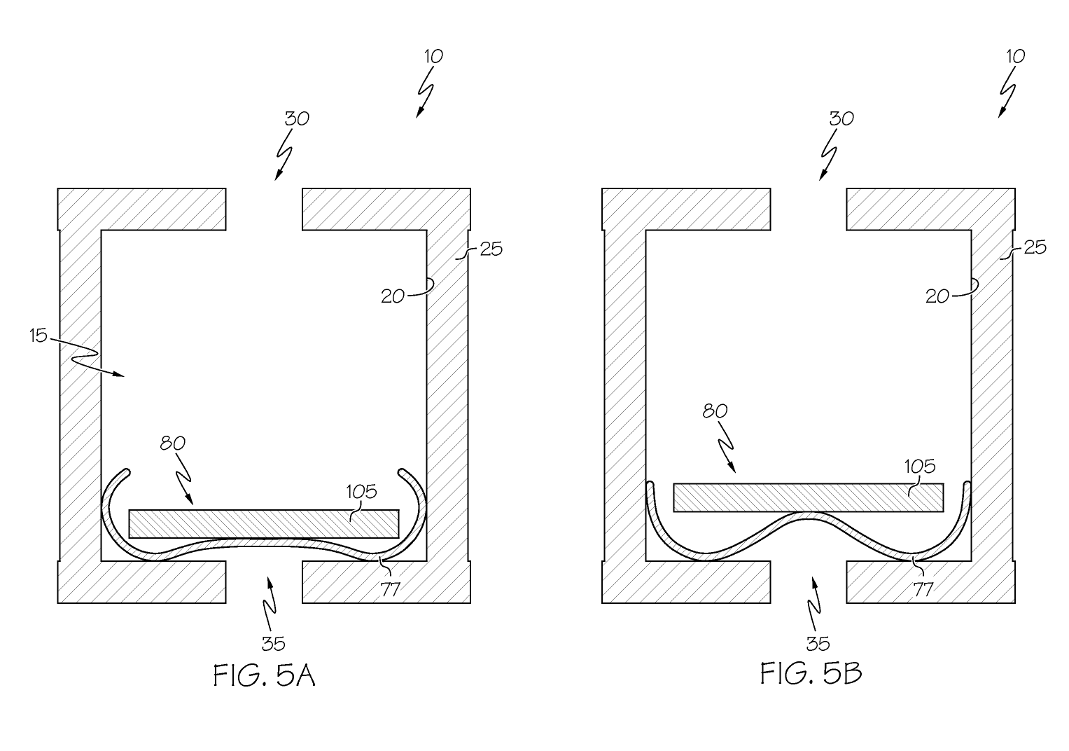

FIGS. 5A and 5B depict another embodiment of the check valve 80 of the drain plug 10. A wave spring 77 is compressed between the carrier 25 and a plate 105 as shown in FIG. 5A and is restrained in the closed position by the soluble plug 15. As coolant enters the inlet 30 and dissolves the soluble plug 15, the wave spring 77 springs to the open position as shown in FIG. 5B allowing the coolant to exit the battery pack through the outlet 35. The wave spring 77 may be made from any material that provides a biasing force to include 1090 ASM spring steel.

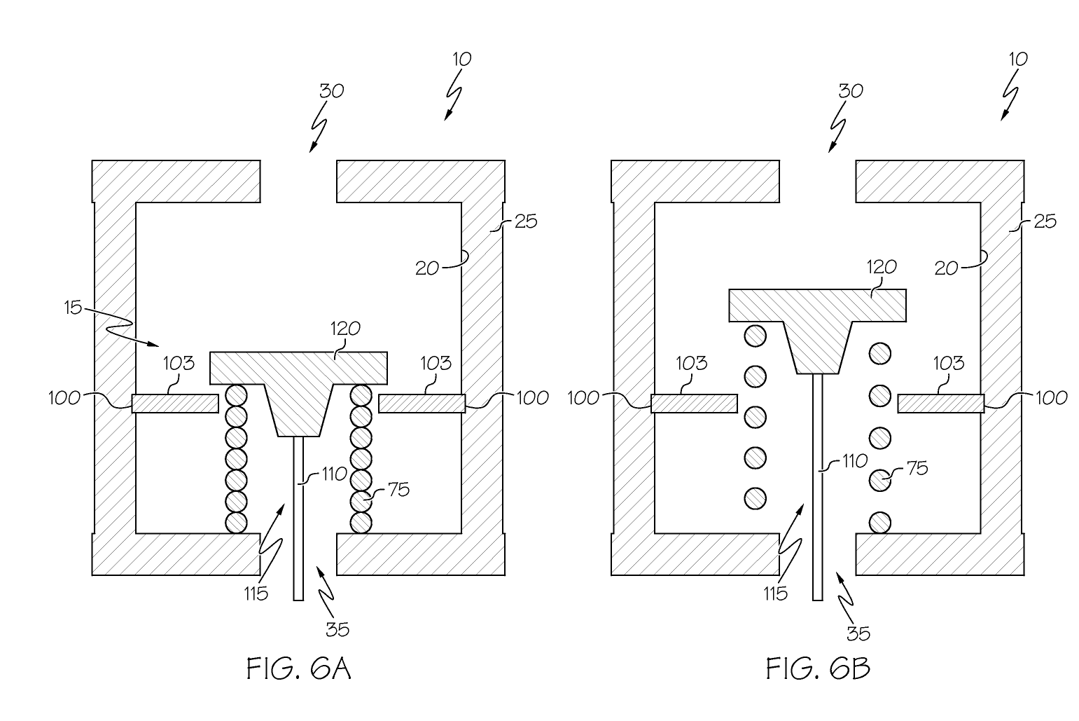

FIGS. 6A and 6B depict yet another embodiment of the check valve of the drain plug 10. The check valve is a plunger 115. A coil spring 75 is restrained in the closed position as shown in FIG. 6A by the soluble plug 15. The seal 100 is disposed below a plunger head 120 to provide a sealing surface 103 between the plunger head 120 and the seal 100 to keep out external moisture from entering the drain plug 10. A shaft 110 exits the drain plug 10 through the outlet 35 and is used to keep the plunger head 120 seated on the seal 100 and radially aligned with the coil spring 75. Radially aligned means that the coil spring 75, seal 100, inlet 30, outlet 35, and plunger head 120 each have a center point that aligns with each other. As coolant enters the inlet 30 and dissolves the soluble plug 15, the coil spring 75 springs to the open position as shown in FIG. 6B, allowing the coolant to exit the battery pack through the outlet 35. The coil spring 75 may be made from any material that provides a biasing force to include 1090 spring steel.

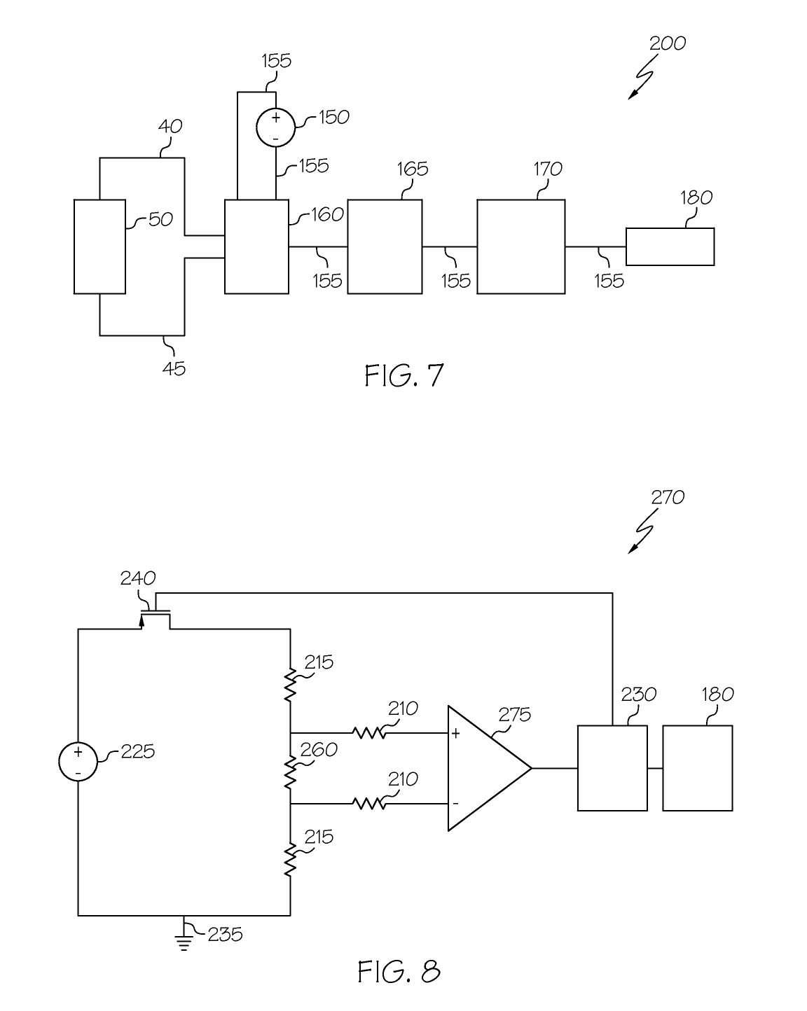

FIG. 7 is a schematic view of the circuit 200 used in the some of the embodiments described above to provide the indication that a coolant leak has occurred in the battery pack. The circuit 200 monitors the change in resistance of the impedance element 50 while the soluble plug may be dissolving. When the threshold resistance value is crossed, the circuit 200 provides an indication that a coolant leak has occurred. The indication notifies a computer control system 180 of the vehicle or a driver that there is the coolant leak. The circuit 200 may be electrically connected to the impedance element 50 of the drain plug through the first lead 40 and the second lead 45. The circuit 200 may have two or more component sets electrically connected by a plurality of electrical connections 155 to provide the indication. A first component set 160 may be a detection circuit such as a fall-away circuit 270, a bridge measurement circuit, or any other circuit that can detect a change in impedance. A second component set 165 may be a comparator circuit which may be an op-amp circuit, or a dedicated comparator chip. The second component set 165 senses a change in the resistance of the circuit of the first component set 160 and provides an indication output that the threshold resistance value has been crossed in the first component set 160. A third component set 170 may be an analog to digital (A/D) circuit to output a digital signal for use by the computer control system. A voltage source 150 is connected to the circuit 200 by the plurality of electrical connections 155 to power the circuit 200 and may be electrically connected to any of the two or more component sets. The voltage source 150 is shown to be electrically connection to the first component set 160 in FIG. 7. The circuit 200 may be a dedicated printed circuit, part of a larger circuit board integrated with the computer control system, be an application specific integrated circuit (ASIC), or have the electrical components printed and or secured on the soluble plug 15 and/or carrier 25 of FIG. 2.

FIG. 8 is a schematic of a fall-away circuit 270 to measure the impedance of the soluble plug 15, and the change in the impedance as the soluble plug dissolves. The impedance of the soluble plug is represented by a fall-away resistor 260. A high precision differential op-amp 275 and the plurality of op-amp resistors 210 define a high precision differential op-amp circuit used to measure the impedance of the fall-away resistor 260 in a Femto range of impedance. The acute sensitivity of the high precision differential op-amp circuit may allow the fall-away circuit 270 to indicate that the soluble plug is starting to dissolve before the soluble plug fully dissolves and drains the coolant. The voltage source 225 in conjunction with the ground source 235 powers the double strain gauge circuit 255. The high speed pulsing switch 240 synchronizes the output of an op-amp 222 to the A/D circuit 230 for output to the computer control system 180. The plurality of op-amp resistors 210 help regulate the op-amp current and may also be equal in resistance value.

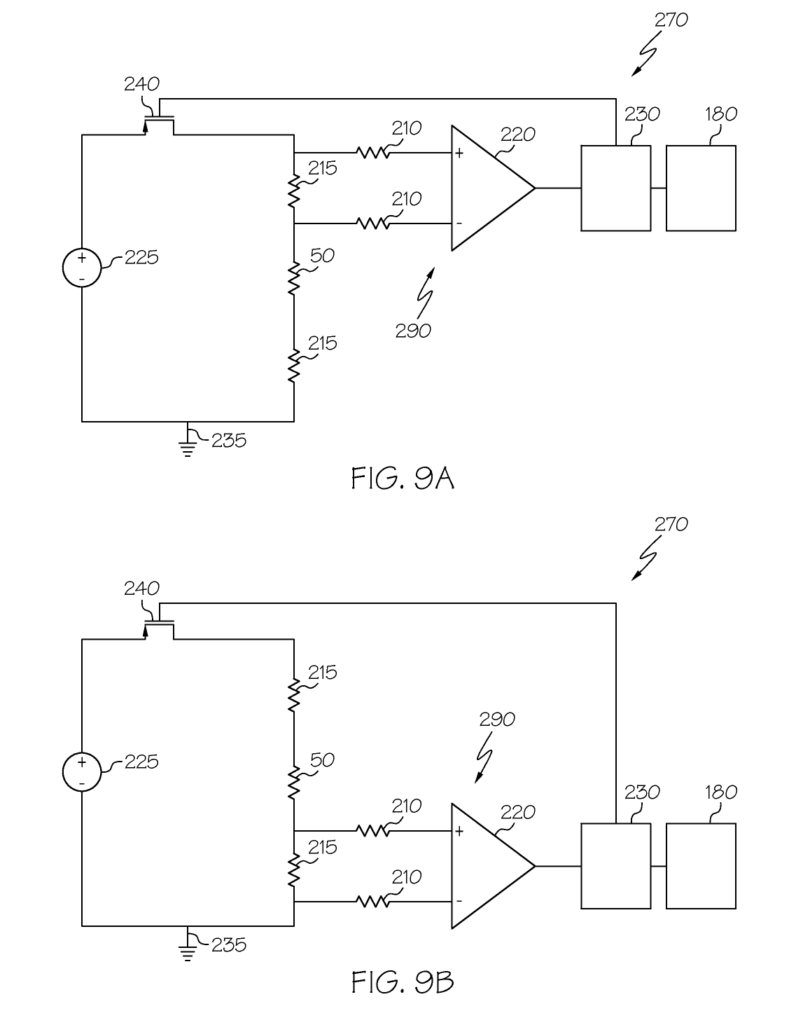

FIGS. 9A and 9B are a schematic view of another embodiment of the fall-away circuit 270 using the impedance element 50 as shown in FIG. 2. The voltage source 225 in conjunction with the ground source 235 provides the voltage differential needed to power the pall out circuit 280. The high speed pulsing switch 240 synchronizes the output of an op-amp 222 to the A/D circuit 230 for output to the computer control system 180. As described in FIG. 2, the impedance element 50 may be the conductive coating on the surface of the soluble plug or the conductive ring within the soluble plug. As the soluble plug dissolves, the impedance element 50 breaks apart and may create an open circuit in the fall-away circuit 270. The op-amp 222 and the plurality of op-amp resistors define the comparator circuit 290 that detects the open circuit and provides the wave signal to the A/D circuit 230 indicating the impedance element 50 has broken and thus the soluble plug has dissolved. The plurality of resistors 215 may have an equal resistance to keep the fall-away circuit 270 balanced. The comparator circuit 290 may be placed across either of the plurality of resistors 215 as shown in FIG. 9A and FIG. 9B.

The fall-away circuit 270 could also indicate the soluble plug has dissolved with a short circuit instead of the open circuit of the impedance element 50. Referring to FIG. 3, the first lead 40 and the second lead 45 could simple end in the cavity 20 and the impedance element 50 as shown in FIGS. 9A and 9B would be an open circuit. The stopper 70 may be made from stainless steel. When the soluble plug 15 dissolves, the stopper 70 will be pushed toward the inlet 30 and electrically connect the first lead 40 to the second lead 45, and thus creating the short circuit. The comparator circuit 290 would detect the short circuit and provide the wave signal to the A/D circuit 230 indicating the first lead 40 and the second lead 45 are electrically connected and thus the soluble plug has dissolved.

It should be understood that the first component set 160 may be disposed within the cavity 20 or coupled to the carrier 25. The dummy gauge 250, the plurality of resistors, 215, and/or the variable resistor 217 may be imprinted on a circuit board, the soluble plug 15, or the inside of the carrier 25 within the cavity 20. Furthermore, the dummy gauge 250, the plurality of resistors 205, and/or the variable resistor 217 may be coupled to the exterior of the carrier 25.

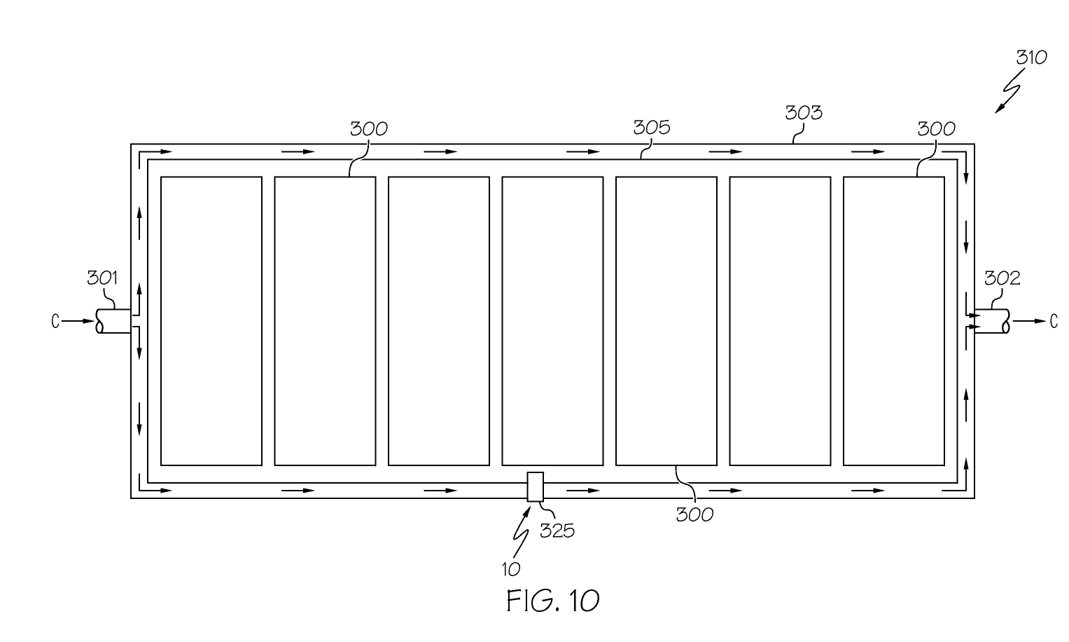

FIG. 10 illustrates a plurality of batteries 300 located within a battery housing 305 of a liquid cooled battery pack 310. A liquid coolant (the coolant) flows through a cooling circuit “C” around the battery housing 305 too cool and maintain a temperature of the liquid cooled battery pack 310. The cooling circuit “C” comprising a containment vessel 303 couple with a cooling inlet 301 and a cooling outlet 302 and enclosing the battery housing 305. A drain outlet 325 may be located anywhere along the battery housing 305 and may not drain back into the cooling circuit “C”. The drain plug 10 may be disposed within the drain outlet 325 and drain the liquid coolant from the battery housing 305 in the event of a leak. When the coolant penetrates the battery housing, the soluble plug 15 from FIG. 2 in the drain plug 10 may start to partially dissolve when fluidly coupled with the coolant and allow a portion of the coolant to flow between the battery housing 305 and the drain outlet 325. In some embodiments, the plurality of batteries may be lithium-ion batteries.

It is noted that terms like “preferably,” “commonly,” and “typically” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention. Likewise, for the purposes of describing and defining the present invention, it is noted that the term “device” is utilized herein to represent a combination of components and individual components, regardless of whether the components are combined with other components. For example, a “device” according to the present invention may comprise an electrochemical conversion assembly or fuel cell, as well as a larger structure (such as a vehicle) that incorporates an electrochemical conversion assembly according to the present invention. Moreover, the term “substantially” is utilized herein to represent the inherent degree of uncertainty that may be attributed to any quantitative comparison, value, measurement, or other representation. As such, it may represent the degree by which a quantitative representation may vary from a stated reference without resulting in a change in the basic function of the subject matter at issue.

Having described the invention in detail and by reference to specific embodiments thereof, it will be apparent that modifications and variations are possible without departing from the scope of the invention defined in the appended claims. More specifically, although some aspects of the present invention are identified herein as preferred or particularly advantageous, it is contemplated that the present invention is not necessarily limited to these preferred aspects of the invention.

What is claimed is:

1. A liquid cooled battery pack apparatus comprising:
a plurality of batteries;
a cooling circuit comprising a containment vessel coupled with a cooling inlet and a cooling outlet and enclosing a battery housing, the battery housing enclosing the plurality of batteries and comprising a drain outlet;
a drain plug disposed within the drain outlet comprising:
a carrier defining a cavity therein;
an inlet disposed on a first surface of the carrier,
an outlet disposed on a second surface of the carrier, the first surface and the second surface fluidly displaced from one another and coupled to the cavity;
a soluble plug disposed within the cavity of the carrier;
an impedance element cooperative with the carrier;
a circuit configured to detect a loss of continuity in the impedance element and provide an indication;
a first lead and a second lead to electrically couple the impedance element to the circuit, wherein the soluble plug is configured to at least partially dissolve when fluidly coupled with a coolant allowing a portion of the coolant to flow between the battery housing and the drain outlet.

2. The battery pack of claim 1, wherein the impedance element is the soluble plug.

3. The battery pack of claim 1, wherein the impedance element is a conductive coating on a surface of the soluble plug.

4. The battery pack of claim 1, wherein the circuit is a comparator circuit.

5. The battery pack of claim 1, wherein the soluble plug is configured to at least partially dissolve when fluidly coupled with a coolant allowing a portion of the coolant to flow between the inlet and the outlet.

6. The battery pack of claim 1 wherein the soluble plug is non-soluble core with a soluble polymer coating.

7. The battery pack of claim 1, further comprising a check valve comprising a stopper within the cavity, and a spring configured to bias the stopper against the soluble plug within the cavity.

8. The battery pack of claim 1, wherein the impedance element is disposed within the cavity.

9. The battery pack of claim 8, wherein the plurality of batteries comprise lithium-ion batteries.

10. A method of draining a liquid coolant from an automotive liquid cooled battery pack, the method comprising:
circulating the liquid coolant around a battery housing of a battery pack;
draining the liquid coolant from the battery housing with a drain plug in the event of a leak, the drain plug comprising:
a carrier defining a cavity therein;
an inlet disposed on a first surface of the carrier,
an outlet disposed on a second surface of the carrier, the first surface and the second surface fluidly displaced from one another and coupled to the cavity;
a soluble plug disposed within the cavity of the carrier; and
an impedance element cooperative with the carrier; and
indicating when the leak occurs using a circuit configured to detect a loss of continuity in the impedance element.

11. The method of claim 10, wherein the impedance element is the soluble plug.

12. The method of claim 10, wherein the impedance element is a conductive coating on a surface of the soluble plug.

13. The method of claim 10, wherein the circuit is a comparator circuit.

14. The method of claim 10, wherein the soluble plug is non-soluble core with a soluble polymer coating

15. The method of claim 10, wherein the drain plug further comprising a check valve comprising a stopper within the cavity, and a spring configured to bias the stopper against the soluble plug within the cavity.

16. The method of claim 10, wherein the soluble plug is configured to at least partially dissolve when fluidly coupled with a coolant allowing a portion of the coolant to flow between the inlet and the outlet.

17. The method of claim 10, wherein the impedance element is disposed within the cavity.
